(19) United States
(12) Patent Application Publication
(10) Pub. No.: US 2007/0201459 A1
(43) Pub. Date: Aug. 30, 2007

(54) System and method for providing status notification for conventional telephony devices in a session initiation protocol environment

(75) Inventors: Ho Bao, Richardson, TX (US); Denise G. Caballero-McCann, Raleigh, NC (US); Ta-Ming Chen, Cary, NC (US); Yuan-Cheng Lan, Cary, NC (US); Christopher E. Pearce, Dallas, TX (US); Kannan Rajagopalan, Apex, NC (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/364,706

(22) Filed: Feb. 27, 2006

(51) Int. Cl. H04L 12/56

(52) U.S. Cl. 370/389; 370/401

(57) ABSTRACT

The present invention comprises a system and method for status notification. The method comprises receiving a subscription message from a first endpoint requesting status data for a second endpoint; detecting a change in status data of the second endpoint; and notifying the first endpoint of the change in status. The subscription message comprises a resource identifier associated with the second endpoint.

### TECHNICAL FIELD OF THE INVENTION

This invention relates in general to communications, and more particularly to a system and method for providing status notification for conventional telephony devices in a Session Initiation Protocol (SIP) environment.

### BACKGROUND OF THE INVENTION

The field of communications has become increasingly important in today's society. In particular, the ability to quickly and effectively interact with an individual (through any suitable communications media) presents a significant obstacle for component manufacturers, system designers, and network operators. This obstacle is made even more difficult due to the plethora of diverse communication technologies that exist in the current marketplace.

As new communication architectures (such as the Session Initiation Protocol (SIP) and the Voice Over Internet Protocol (VoIP)) become available to the consumer, new processes need to be developed in order to optimize this emerging technology. For example, VoIP and SIP have created a foundation for supporting enhanced services based on presence information, but communication systems often have a variety of devices and protocols that are unable to exchange such information natively. For presence information to be truly empowering, communication systems need to be able to collect and publish the status of all devices in a heterogeneous environment, regardless of hardware or protocol.

### SUMMARY OF THE INVENTION

In accordance with the present invention, the disadvantages and problems associated with collecting and publishing status information in a heterogeneous communications environment have been substantially reduced or eliminated.

In accordance with one embodiment of the present invention, a method is provided for status notification. The method comprises receiving a subscription message from a first endpoint requesting status data for a second endpoint; detecting a change in status data of the second endpoint; and notifying the first endpoint of the change in status. The subscription message comprises a resource identifier associated with the second endpoint.

In accordance with another embodiment of the present invention, a system is provided for status notification. The system comprises a subscriber component for receiving a subscription message from a first endpoint requesting status data for a second endpoint, the subscription message comprising a resource identifier associated with the second endpoint; a subscription manager component for detecting a change in status data of the second endpoint; and a notifier component for sending a notify message to the first endpoint to describe the change in status.

An important technical advantage of certain embodiments of the present invention includes functionality for collecting status information, such as presence data, from a wide variety of devices in a heterogeneous communications environment. Other technical advantages of the present invention may be readily apparent to one skilled in the art from the following figures, descriptions, and claims. Moreover, while a specific advantage has been enumerated above, various embodiments may not include this enumerated advantage, or may include additional or alternative advantages not enumerated.

### BRIEF DESCRIPTION OF THE DRAWINGS

For a more complete understanding of the present invention and its advantages, reference is now made to the following description, taken in conjunction with the accompanying drawings, in which:

FIG. 1 is a simplified block diagram of a communication system 10 for exchanging data in accordance with certain teachings of the present invention;

FIG. 2 is a simplified diagram that illustrates the general Sub/Not processing architecture for line status; and

FIGS. 3-8 are simplified flow diagrams that illustrate certain example operations of the present invention.

### DETAILED DESCRIPTION OF THE INVENTION

For purposes of teaching and discussion, it is useful to provide an overview of a communication system in which certain features of the present invention may be implemented. The following foundational information may be viewed as a basis from which the present invention may be properly explained. Such information is offered earnestly for purposes of explanation only and, accordingly, should not be construed in any way to limit the broad scope of the present invention and its potential applications.

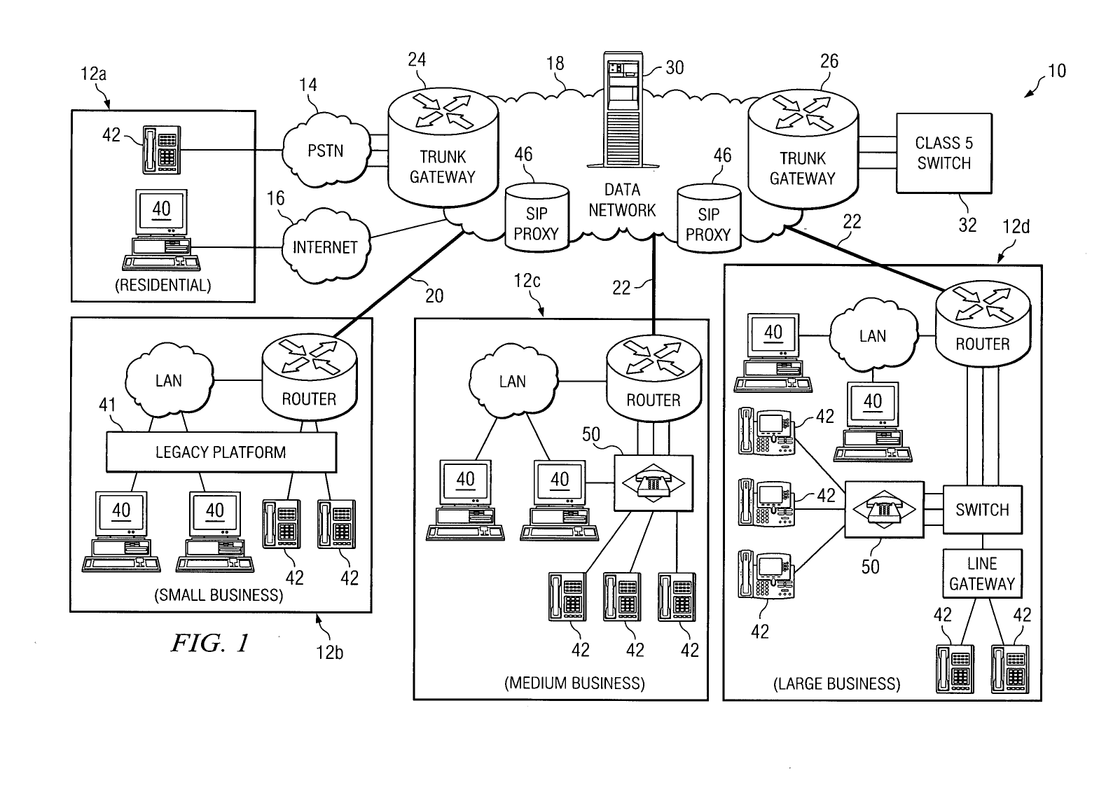

FIG. 1 is a simplified block diagram of a communication system 10 for exchanging data in accordance with certain teachings of the present invention. Communication system 10 includes domains 12a-12d, a public switched telephone network (PSTN) 14, a wide-area network 16 (such as the Internet), a data network 18, a broadband access link 20, and a number of additional links 22. Additional links 22 may include, for example, a digital subscriber line (DSL) link, a T1 link, a fiber optic link, or a wireless link. Communication system 10 also includes a set of trunk gateways 24 and 26, a third-party application server 30, and a Class-5 switch 32.

Each domain may include suitable network equipment and appropriate infrastructure (e.g., switches, routers, LANs, gateways, etc.) to facilitate a SIP session. Domain 12a represents a residential location, which consists of a computer 40 and a telephone 42. Telephone 42 may be an Internet protocol (IP) telephone or a standard telephone operable to interface with computer 40 such that one or more calling capabilities are enabled through telephone 42. Accordingly, two types of telephones are illustrated in FIG. 1. Domain 12b represents a small business entity, which consists of a local area network (LAN), a router, several computers 40, and several telephones 42. In addition, domain 12b may include a legacy platform 41, which is operable to communicate with each telephone 42 and/or computer 40.

Domain 12c represents a medium business entity, which consists of a LAN, router, a private branch exchange (PBX) or key system, several computers 40, and several telephones 42. Domain 12d is a large business entity, which consists of a LAN, a router, a switch, a line gateway, several computers 40, and several telephones 42. Note that domains 12c and 12d each include a communications platform 50, which is operable to communicate with any number of “endpoints” (e.g., telephones 42 and/or computer 40). In one embodiment, communications platform 50 is a Call Manager element, which is manufactured by Cisco Systems, Inc. of San Jose, Calif. The Call Manager element is SIP-enabled. In other embodiments, communications platform 50 may be any suitable unit operable to interface with end-user devices (e.g., telephone 42, computer 40, etc.).

Note that the term “endpoint” encompasses a myriad of potential devices and infrastructure that may benefit from the operations of communication system 10. Endpoints may represent a personal digital assistant (PDA), a cellular telephone, a standard telephone (which may be coupled to a personal computer), an IP telephone, a personal computer, a laptop computer, a mobile telephone, or any other suitable device or element (or any appropriate combination of these elements) that is operable to receive data or information. FIG. 1 illustrates only one set of example devices that may be used within communication system 10. The present invention is replete with numerous alternatives that could be used to facilitate the operations of communication system 10.

It should also be noted that the internal structure of the endpoints are malleable and can be readily changed, modified, rearranged, or reconfigured in order to achieve their intended operations, as they pertain to certain features of the present invention. Note also that the endpoints can each include a link to communications platform 50, which is operable to communicate with any number of endpoints/user agents/devices. As indicated above, in one embodiment, communications platform 50 may be a Call Manager element, which is manufactured by Cisco Systems, Inc. of San Jose, Calif. The Call Manager element is SIP-enabled, and it can readily accommodate other protocols (e.g., H.323). In other embodiments, communications platform 50 is any suitable component (e.g. a gateway, a switch, a router, a bridge, a state machine, a processor, etc.) that is operable to interface with endpoints/end-users.

As outlined above, software and/or hardware may reside in communications platform 50 in order to achieve certain teachings of the present invention. However, due to its flexibility, communications platform 50 may alternatively be equipped with (or include) any suitable component, device, application specific integrated circuit (ASIC), processor, microprocessor, algorithm, read-only memory (ROM) element, random access memory (RAM) element, erasable programmable ROM (EPROM), electrically erasable programmable ROM (EEPROM), field-programmable gate array (FPGA), or any other suitable element or object that is operable to facilitate the operations thereof. Considerable flexibility is provided by the structure of communications platform 50 in the context of communication system 10 and, accordingly, it should be construed as such.

Endpoints in communication system 10 communicate with each other and with communications platform 50 through various communication protocols, including SIP. Thus, for purposes of teaching and discussion, it is useful to provide some overview of the way in which the following invention operates in a SIP environment. The following foundational information may be viewed as a basis from which the present invention may be properly explained. Such information is offered earnestly for purposes of explanation only and, accordingly, should not be construed in any way to limit the broad scope of the present invention and its potential applications.

SIP is an application-layer control protocol that can establish, modify, and terminate multimedia sessions (conferences) such as Internet telephony calls. SIP can also invite participants to already existing sessions, such as multicast conferences. Media can be added to (and removed from) an existing session. SIP transparently supports name mapping and redirection services, which supports personal mobility. End users can maintain a single externally visible identifier regardless of their network location.

In general, SIP supports five facets of establishing and terminating multimedia communications: 1) user location (determining the end system to be used for communication); 2) user availability (determining the willingness of the called party to engage in communications); 3) user capabilities (determining the media and media parameters to be used); 4) session setup (“ringing” and establishment of session parameters at both called and calling party locations); and 5) session management (including transfer and termination of sessions, modifying session parameters, and invoking services).

A standard SIP platform does not provide services. Rather, SIP provides primitives that can be used to implement different services. For example, SIP can locate a user and deliver an opaque object to his current location. If this primitive is used to deliver a session description written in SDP, for instance, the endpoints can agree on the parameters of a session. SIP can function with SOAP, HTTP, XML, SDP, and a variety of other protocols to implement services.

Endpoints in a SIP environment communicate by exchanging messages, which may be either a “request” or a “response.” Generally, an endpoint (also sometimes referred to as a “user agent” or “UA” in a SIP environment) operates as either a User Agent Client (UAC) or a User Agent Server (UAS), although a single endpoint can (and often does) operate as both a UAC and a UAS. A UAC generates requests and sends them to one or more UASs. A SIP proxy, such as SIP proxy 46 in FIG. 1, often facilitates message exchanges between SIP endpoints. A UAS receives requests, processes them, and sends responses.

SIP also provides a mechanism for endpoints to be notified of certain events within a SIP environment. In particular, SIP provides a SUBSCRIBE method and a NOTIFY method (which may include an event package). A first SIP endpoint (i.e. the “subscriber”) sends a SIP request with a SUBSCRIBE method to a second SIP endpoint (i.e. the “notifier”) to request state information about some resource. If the subscription is accepted, the notifier is responsible for sending SIP messages with the NOTIFY method to notify provide the requested state information to the subscriber. Notifications may be triggered by a certain event, a timer, or some other mechanism. For example, a first endpoint may send a SUBSCRIBE message to a second endpoint, requesting notification of changes in the second endpoint's state. If the second endpoint accepts subscription from the first endpoint, the second endpoint will then send a NOTIFY message when its state changes.

For purposes of teaching, it is assumed that communication platform 50 is configured to monitor the state of endpoints and other devices within communication system 10. Thus, communication platform 50 may detect state changes in one or more telephones 42. In accordance with certain teachings of the present invention, communication platform 50 also may be configured to accept SIP SUBSCRIBE requests and send corresponding SIP NOTIFY messages. In one embodiment of the present invention, SIP SUBSCRIBE requests may comprise a “resource identifier” that identifies a particular endpoint in communication system 10. A resource identifier may correspond to a line number, a uniform resource indicator (URI), or any other type of identifier within a given addressing scheme. In accordance with certain teachings of the present invention, communication platform 50 analyzes the resource identifier in a SUBSCRIBE request and compares it to a pre-configured pattern collection. Each pattern in the collection represents a set of addresses that are bound to different resources. In many cases, the addresses bind to an endpoint or a gateway. If communication platform 50 determines that the URI is associated with an endpoint (SIP or non-SIP) within its domain, then communication platform 50 acts on behalf of the endpoint to provide notifications. If the URI is associated with a SIP endpoint external to the domain of communication platform 50, then communication platform 50 generates a new SUBSCRIBE request and sends it to the appropriate network. Thus, given a SUBSCRIBE request with a resource identifier, communication platform 50 may identify an endpoint within communication system 10, maintain or forward a SIP subscription for the endpoint, and issue SIP NOTIFY messages describing an endpoint state—even if the endpoint is not a SIP endpoint.

To further illustrate certain features of the present invention, an embodiment of the invention is described below in which communication platform 50 is a Call Manager (CM) element. A “Sub/Not” component and event package classes in the CM support the SIP SUBSCRIBE and NOTIFY messages, as specified in IETF RFC 3265. The Sub/Not component provides the infrastructure to understand the semantics of the SIP SUBSCRIBE and NOTIFY messages. It also performs SIP protocol specific subscription handling, such as subscription renewal, response, notification, termination and timer handling.

Internal to CM, the SIP Sub/Not component consists of new SDL processes, “Subscriber” and “Notifier,” and event package objects. A “SIPStation” component creates the Notifier in order to process SIP Subscribe messages coming into CM, and to send out notifications. It also creates the Subscriber in order to send out SIP Subscribe requests from CM and to receive Notify messages coming into CM. A given Notifier or Subscriber SDL process will handle only one event package instance in a SIP subscription, since every event package instance corresponds to a separate subscription state machine.

Additionally, the Sub/Not SDL processes interface with other components of CM. For example, to obtain line status information, they interface with a Subscription Manager, which holds the list of current subscriptions, and brokers the line status on behalf of endpoints.

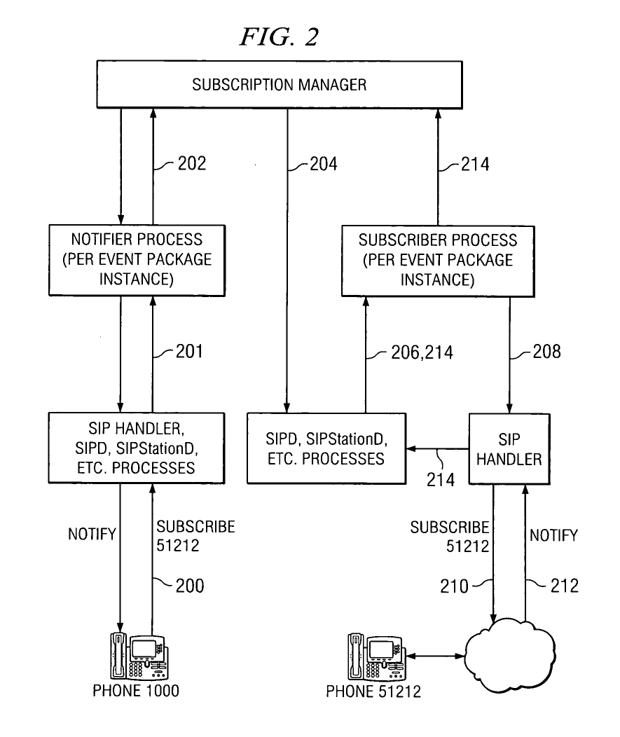

FIG. 2 is a simplified diagram that illustrates the general Sub/Not processing architecture for line status. At step 200, a Subscribe request coming into CM results in the creation of a Notifier process (step 201). The request then bubbles up the protocol layer of CM to the Subscription Manager (SM) (step 202). If the Subscribe request should be sent to an external entity (step 204), a Subscriber process is created (step 206) at the device layer, and the request flows down the layers of CM (step 208), out to the network (step 210). When an external status notification comes into CM (step 212), it is handled by the Subscriber process, and bubbled up the protocol layer of CM to SM (step 214). SM acts as the status broker and sends out notifications to all the interested parties whenever it knows of a status change.

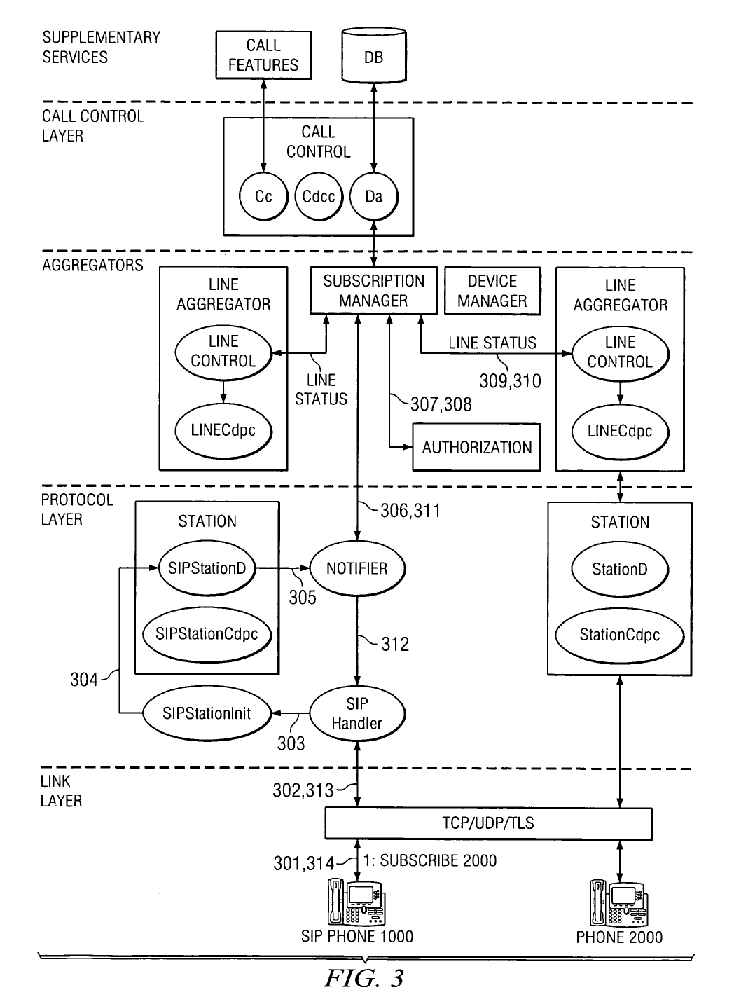

FIGS. 3-8 are simplified flow diagrams that illustrate certain example operations of the present invention. For purposes of teaching, these diagrams track the flow of information through the system at a high level. The details of the SIP message headers are not considered in this discussion.

FIG. 3 is a simplified flow diagram that illustrates a line-to-line subscription for status. In FIG. 3, communication platform 50 is a CM connected to two phones, 1000 and 2000, which are both on the line side of the CM. At steps 301-302, phone 1000 sends a SIP SUBSCRIBE message to CM with a presence event package requesting status of phone 2000. At steps 303-304, the SIP handler component of CM parses the message and sends it to SIPStationD. Next, at step 305, SIPStationD checks if the message belongs to an existing Subscription dialog. If so, it sends the message to the corresponding Notifier; if not, it creates a Notifier process to handle the new subscription. At step 306, the Notifier interprets the SIP subscription message, starts needed SIP timers, and sends the subscription information to the Subscription Manager (SM). At steps 307-308, SM consults the Authorization module to check if phone 1000 is allowed to subscribe for the status of phone 2000. At step 309, SM internally subscribes to Line Control for the status of phone 2000, if it has not already subscribed in the context of a different Notifier. Then, in steps 310-311, Line Control informs SM of any status change of phone 2000. SM caches that information and also informs the Notifier. Finally, in steps 312-314, the Notifer constructs a notification message and requests the SIP handler to deliver it to phone 1000.

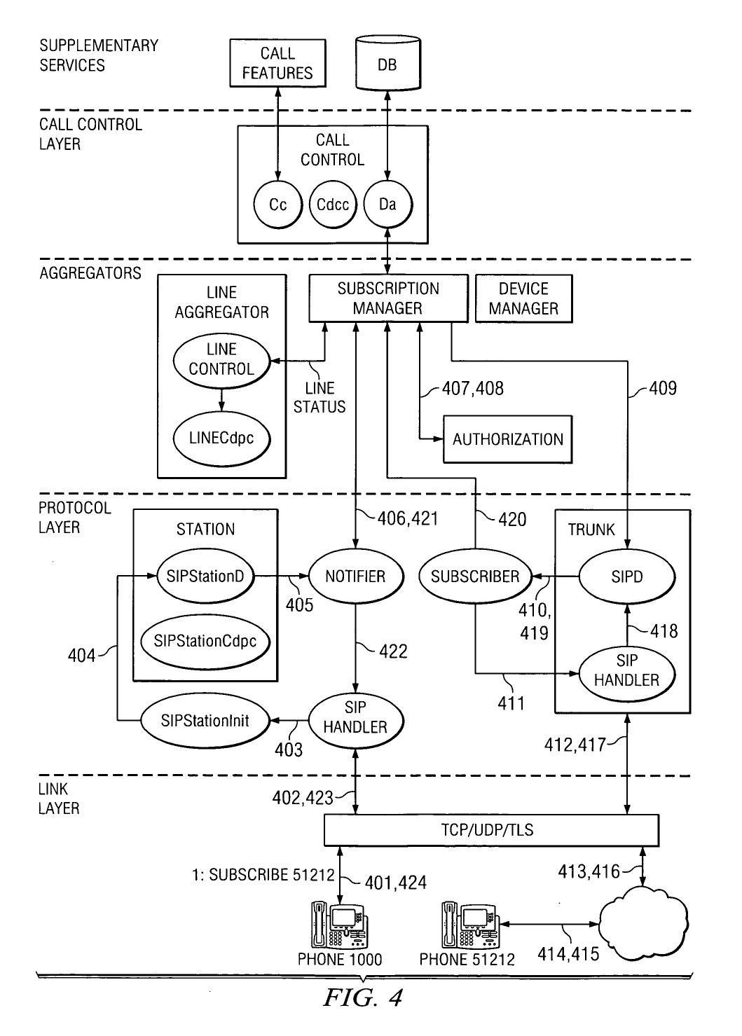

FIG. 4 is a simplified flow diagram that illustrates a line-to-trunk subscription for status. In FIG. 4, communication platform 50 is a CM connected to two phones, line-side phone 1000 and trunk-side phone 51212. Phone 1000 is interested in the status of phone 51212. At steps 401-402, phone 1000 sends a SIP Subscribe message to CM with a presence event package requesting status of phone 51212. At steps 403-404, the SIP handler component of CCM parses the message and sends it to SIPStationD. At step 405, SIPStationD checks if the message belongs to an existing Subscription dialog. If so, it sends the message to the corresponding Notifier; if not, it creates a Notifier process to handle the new subscription. At step 406, the Notifier interprets the SIP subscription message, starts needed SIP timers, and sends the subscription information to the Subscription Manager (SM). At steps 407-408, SM consults the Authorization module to check if phone 1000 is allowed to subscribe for the status of phone 51212. At step 409, SM checks to see if it already has the status of phone 51212. If it does not, then based on information from Digit Analysis (DA), SM forwards the Subscribe request to SIPD for the trunk. Then, in steps 410-414, SIPD creates a Subscriber process which sends out a subscribe request via the SIP Handler to phone 51212. In steps 415-420, phone 51212 sends a notify message which flows back to the Subscriber process, which interprets the status and informs SM. At step 421, SM caches that information and also informs the Notifier. Finally, in steps 422-424, the Notifer constructs a notification message and requests the SIP handler to deliver it to phone 1000.

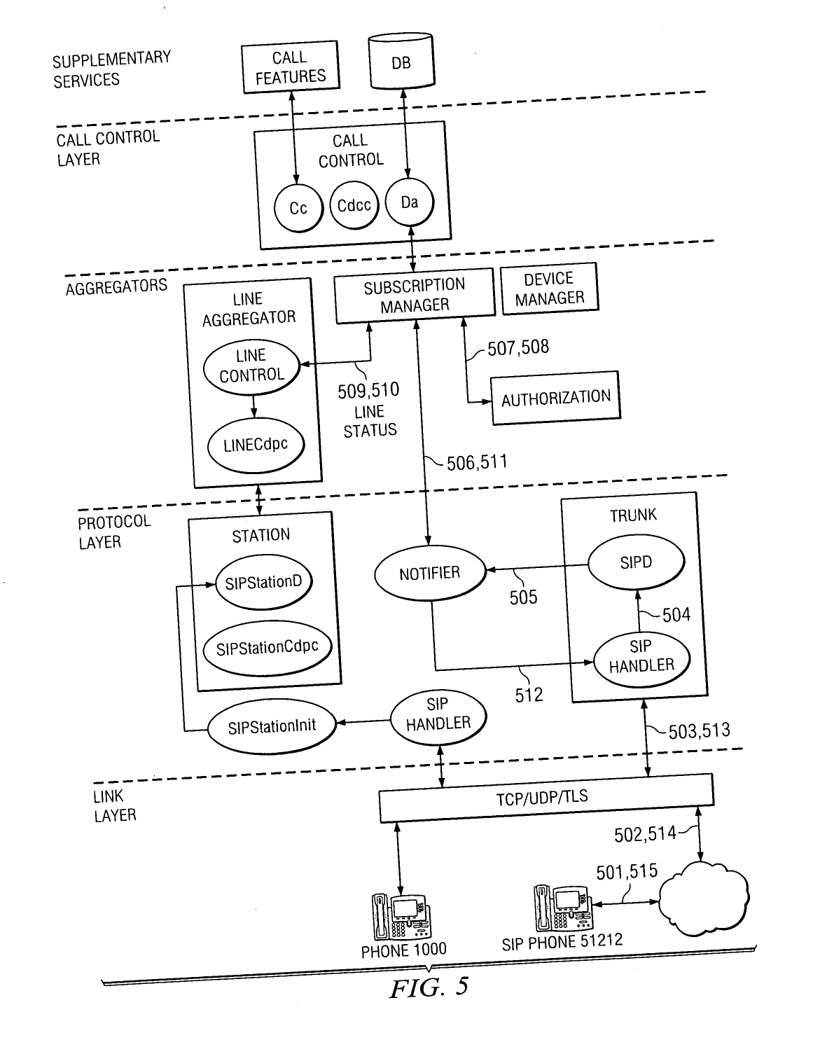

FIG. 5 is a simplified flow diagram that illustrates a trunk-to-line subscription for status. In FIG. 5, communication platform 50 is a CM connected to two phones, line-side phone 1000 and trunk-side phone 51212. Phone 51212 is interested in the status of phone 1000. At steps 501-503, phone 51212 sends a SIP Subscribe message on the SIP trunk to CM with a presence event package requesting status of phone 1000. At step 504, the SIP handler component of CM parses the message and sends it to SIPD. At step 505, SIPD checks if the message belongs to an existing Subscription dialog. If so, it sends the message to the corresponding Notifier; if not, it creates a Notifier process to handle the new subscription. At step 506, the Notifier interprets the SIP subscription message, starts needed SIP timers, and sends the subscription information to the Subscription Manager (SM). Then, in steps 507-508, SM consults the Authorization module to check if trunk side phone 51212 is allowed to subscribe for the status of phone 1000. At step 509, SM internally subscribes to Line Control for the status of phone 1000, if it has not subscribed already in the context of a different Notifier. In steps 510-511, Line Control informs SM of any status change of phone 1000. SM caches that information and also informs the Notifier. Finally, in steps 512-515, the Notifer constructs a notification message and requests the SIP handler to deliver it over the SIP trunk to phone 51212.

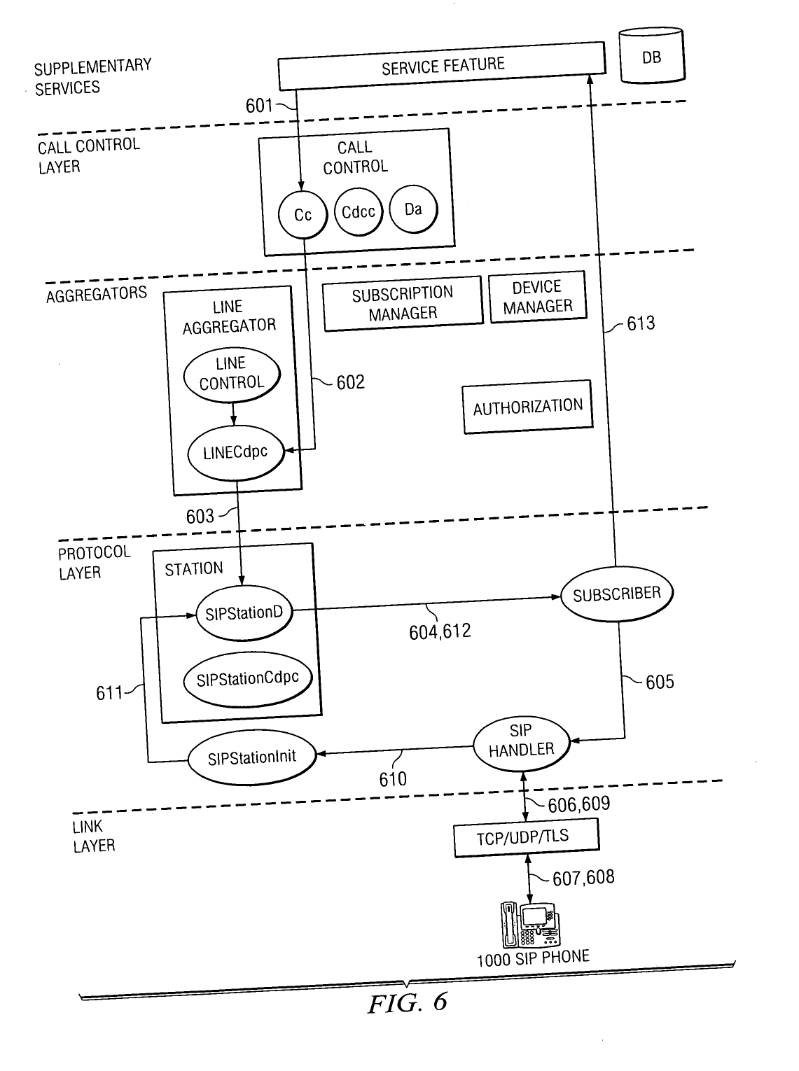

FIG. 6 is a simplified flow diagram that illustrates a subscription to a line for DTMF digits. In this example operation, the Sub/Not component is used for a non-presence related application. A supplementary service feature is interested in the DTMF digits from a line side phone 1000, possibly in the context of an active SIP Invite dialog. At steps 601-603, a service feature requests Call Control (CC) for dialed digits (using a Key-Pad Markup Language (KPML) package) from Phone 1000. CC conveys the request to Line Manager, which then forwards it to SIPStationD. In step 604, SIPStationD creates a Subscriber, requesting subscription for KPML package. In steps 605-607, Subscriber constructs a subscription message and sends it to phone 1000 via the SIP handler. Finally, in steps 608-613, phone 1000 sends back DTMF digits using SIP Notify messages which bubble up the CM layers to the Subscriber and finally back to the service feature.

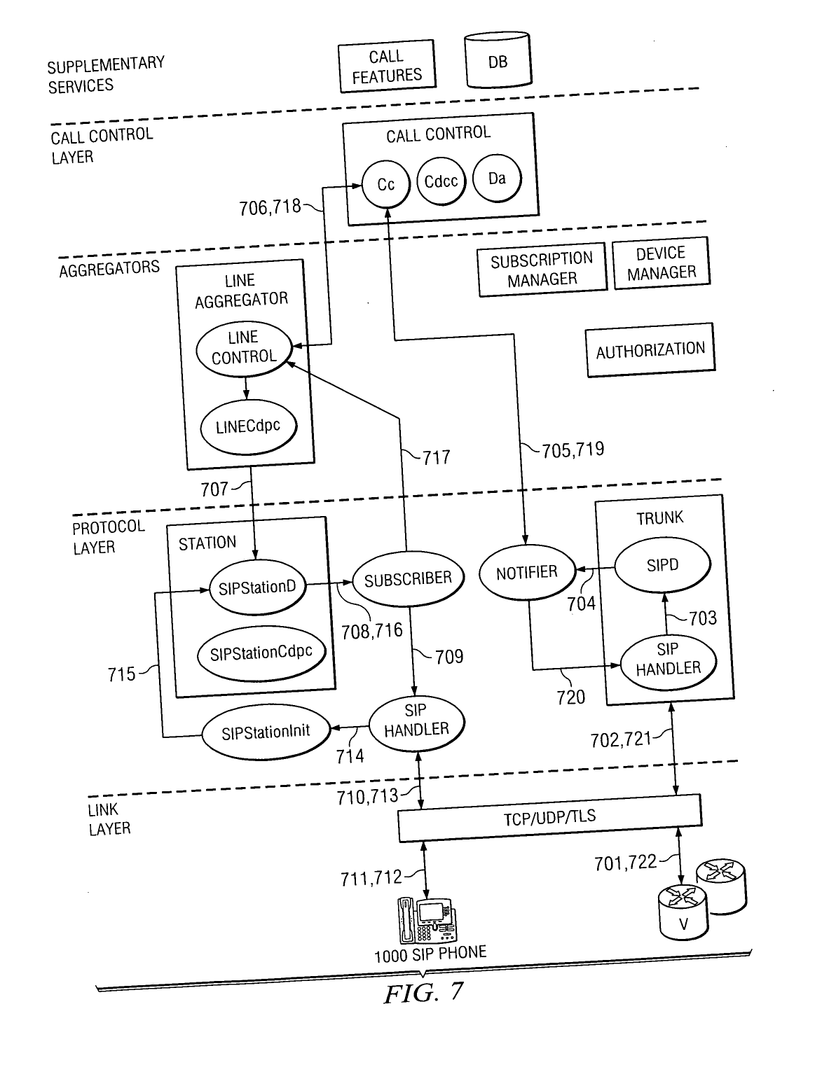

FIG. 7 is a simplified flow diagram that illustrates a subscription to a line for DTMF digits by a trunk-side entity. In this example, an external entity is interested in the DTMF digits from phone 1000. In steps 701-702, A subscribe request comes to CM on the SIP trunk. This request is for the KPML event package from a line side phone. At step 703, the SIP handler component of CM parses the message and sends it to SIPD. Then, in step 704, SIPD checks if the message belongs to an existing Subscription dialog. If so, it sends the message to the corresponding Notifier; if not, it creates a Notifier process to handle the new subscription. Next, at step 705, the Notifier interprets the SIP subscription message, starts needed SIP timers, and sends the subscription information to Call Control. Note that SM is not involved in brokering in the case of DTMF package. In steps 706-707, CC forwards the subscribe request to Line Control, which sends it to SIPStationD. In steps 708-711, SIPStationD creates a Subscriber to send the request out to the line side phone 1000 via the SIP Handler. In steps 712-718, phone 1000 sends SIP Notify messages containing the DTMF digits, which get bubbled back up through the Subscriber to CC. Finally, in steps 719-722, CC forwards the notification to the Notifier, which then sends the SIP Notify via the SIP Handler out on the SIP trunk.

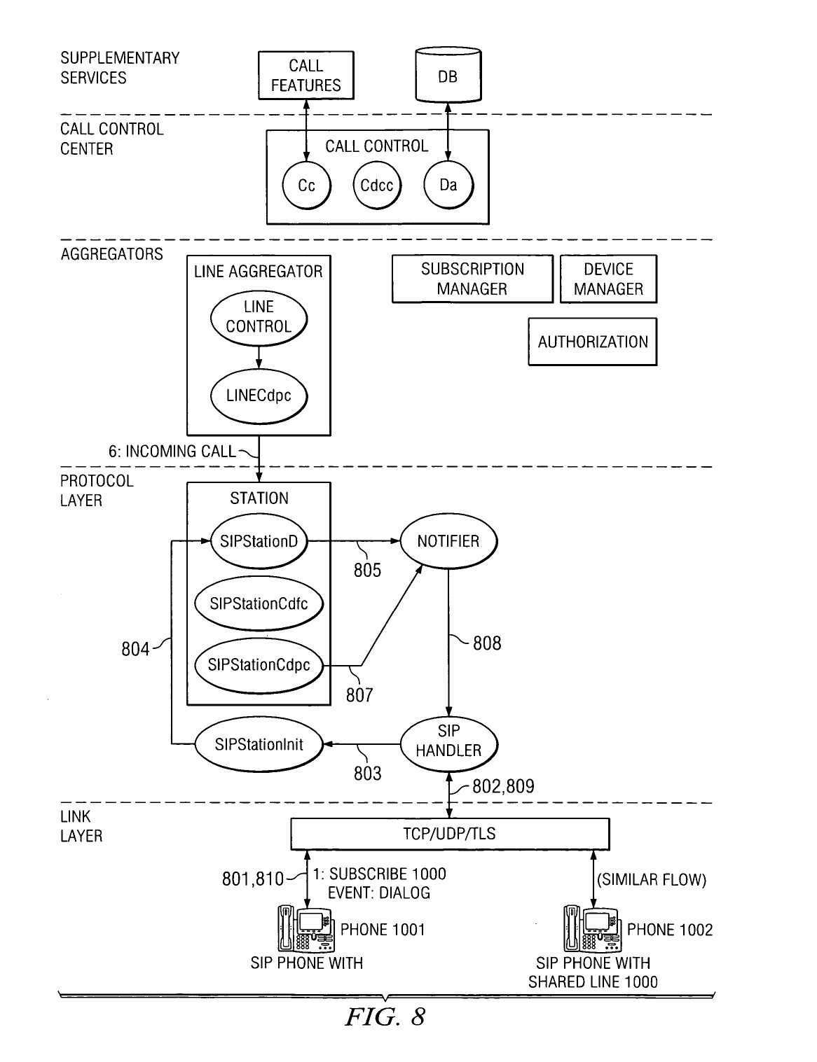

FIG. 8 is a simplified flow diagram that illustrates a shared line subscription for a dialog event package. In FIG. 8, phone 1001 and phone 1002 are coupled to CM and share line 1000. Phone 1001 is interested in the dialog event package in order to display the status of the shared line at any point in time. Accordingly, at steps 801-802, phone 1001 subscribes for the dialog event package as soon as it is configured for a shared line. In steps 803-804, the SIP handler component of CM parses the message and sends it to SIPStationD. In step 805, SIPStationD checks if the message belongs to an existing Subscription dialog. If so, it sends the message to the corresponding Notifier; if not, it creates a Notifier process to handle the new subscription. At a later time, the shared line 1000 is involved in a call setup, either incoming or outgoing. This call setup triggers the SIP station components to send out notifications of the dialog states via the Notifier to the phone, at steps 806-810.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for providing status notification, the method comprising:
receiving a subscription message from a first endpoint requesting status data for a second endpoint, the subscription message comprising a resource identifier associated with the second endpoint;
detecting a change in status data of the second endpoint; and
notifying the first endpoint of the change in status.

2. The method of claim 1, wherein the subscription message is a session initiation protocol subscription message.

3. The method of claim 1, wherein the second endpoint is a telephone.

4. The method of claim 1, wherein the resource identifier is a line number.

5. The method of claim 1, wherein the resource identifier is a uniform resource indicator.

6. The method of claim 1, wherein the step of notifying the first endpoint comprises sending a session initiation protocol notification message to the first endpoint.

7. The method of claim 1, wherein the step of notifying the first endpoint comprises sending a session initiation protocol notification message to the first endpoint; and wherein the session initiation protocol notification message includes an event package.

8. The method of claim 1, wherein the status data is presence data.

9. The method of claim 1, wherein the subscription message is a session initiation protocol subscription message; wherein the second endpoint is a telephone; wherein the resource identifier is a line number; and wherein the step of notifying the first endpoint comprises sending a session initiation protocol notification message to the first endpoint.

10. The method of claim 1, wherein the subscription message is a session initiation protocol subscription message; wherein the second endpoint is a telephone; wherein the resource identifier is a line number; wherein the step of notifying the first endpoint comprises sending a session initiation protocol notification message to the first endpoint; and wherein the session initiation protocol notification message includes an event package.

11. A system for providing status notification, the system comprising:
a subscriber component for receiving a subscription message from a first endpoint requesting status data for a second endpoint, the subscription message comprising a resource identifier associated with the second endpoint;
a subscription manager component for detecting a change in status data of the second endpoint; and
a notifier component for sending a notify message to the first endpoint to describe the change in status.

12. The system of claim 11, wherein the subscription message is a session initiation protocol subscription message.

13. The system of claim 11, wherein the second endpoint is a telephone.

14. The system of claim 11, wherein the resource identifier is a line number.

15. The system of claim 11, wherein the resource identifier is a uniform resource indicator.

16. The system of claim 11, wherein the notify message comprises a session initiation protocol notification message.

17. The system of claim 11, wherein the notify message comprises a session initiation protocol notification message; and wherein the session initiation protocol notification message includes an event package.

18. The system of claim 11, wherein the status data is presence data.

19. The system of claim 11, wherein the subscription message is a session initiation protocol subscription message; wherein the second endpoint is a telephone; wherein the resource identifier is a line number; and wherein the notify message comprises a session initiation protocol notification message.

20. The system of claim 11, wherein the subscription message is a session initiation protocol subscription message; wherein the second endpoint is a telephone; wherein the resource identifier is a line number; wherein the notify message comprises a session initiation protocol notification message; and wherein the session initiation protocol notification message includes an event package.

21. Software embodied in a computer-readable medium comprising computer code such that when executed is operable to:
receive a subscription message from a first endpoint requesting status data for a second endpoint, the subscription message comprising a resource identifier associated with the second endpoint;
detect a change in status data of the second endpoint; and
send a notify message to the first endpoint to describe the change in status.

22. The software of claim 21, wherein the subscription message is a session initiation protocol subscription message.

23. The software of claim 21, wherein the second endpoint is a telephone.

24. The software of claim 21, wherein the resource identifier is a line number.

25. The software of claim 21, wherein the resource identifier is a uniform resource indicator.

26. The software of claim 21, wherein the notify message comprises a session initiation protocol notification message.

27. The software of claim 21, wherein the notify message comprises a session initiation protocol notification message; and wherein the session initiation protocol notification message includes an event package.

28. The software of claim 21, wherein the status data is presence data.

29. The software of claim 21, wherein the subscription message is a session initiation protocol subscription message; wherein the second endpoint is a telephone; wherein the resource identifier is a line number; and wherein the notify message comprises a session initiation protocol notification message.

30. The software of claim 21, wherein the subscription message is a session initiation protocol subscription message; wherein the second endpoint is a telephone; wherein the resource identifier is a line number; wherein the notify message comprises a session initiation protocol notification message; and wherein the session initiation protocol notification message includes an event package.

31. A system for providing status notification, the system comprising:
means for receiving a subscription message from a first endpoint requesting status data for a second endpoint, the subscription message comprising a resource identifier associated with the second endpoint;
means for detecting a change in status data of the second endpoint; and
means for notifying the first endpoint of the change in status.
